(19) United States
(12) Patent Application Publication
(10) Pub. No.: US 2018/0131595 A1
(43) Pub. Date: May 10, 2018

(54) System For Using Kernel To Perform Pressure Test On Communication Port And Method

(71) Applicants: Inventec (Pudong) Technology Corporation, Shanghai (CN); Inventec Corporation, Taipei City (TW)

(72) Inventor: Ting Zhi Yang, Shanghai (CN)

(21) Appl. No.: 15/622,928

(22) Filed: Jun. 14, 2017

(30) Foreign Application Priority Data
Nov. 8, 2016 (CN) 201611035144.6

(51) Int. Cl. H04L 12/26; H04L 12/24

(52) U.S. Cl. CPC H04L 43/50; H04L 41/14

(57) ABSTRACT

The present disclosure illustrates a system for using a kernel to perform a pressure test on a communication port and a method thereof. In the system, a transmission parameter corresponding to a port is set and a test procedure is established on a processor in accordance with the transmission parameter, so that the processor executes a kernel of computer to use a driver of network card based on the transmission parameter to transmit and receive test packets on the communication port. As a result, the system and the method of the present disclosure may generate enough data traffic for pressure test and may achieve the effect of performing test on network device installed difference network cards.

### CROSS-REFERENCE TO RELATED APPLICATION

This application claims the benefit of Chinese Patent Application No. 201611035144.6, filed Nov. 8, 2016.

### BACKGROUND OF THE INVENTION

### 1. Field of the Invention

The present disclosure relates to a system for pressure test and a method thereof, and more particularly to a system for using kernel to perform a pressure test on a communication port, and a method thereof.

### 2. Description of the Related Art

In order to ensure efficiency and stability in network service of a network server, a pressure test is usually performed on network cards of the network server before the network server is on line.

Conventional manner of performing pressure test for the network card is to transmit or receive file through the network card; however, the performance of this manner is limited to data read/write speeds of the two ends which transmit and receive the file respectively, that is, the speed by which the network device, transmitting the file, reads the file from hard disk, or the speed by which the network device, receiving the file, writes the file into hard disk may usually affect the pressure test result.

In order to solve the problem that the data transmission speed is limited by the hard disk read/write speed, a technical resolution, which directly operates an application layer to generate and transmit a large quantity of packets, is developed. However, in this technical solution which directly operates the application layer to generate the packets, the data must be transmitted from the application layer (the seventh layer) to a physical layer (the first layer) to be packed as a complete packet, and then the packet is transmitted, and a processor is required to perform this data packing process. For this reason, this resolution is unable to generate a sufficiently great amount of data traffic for pressure test.

Therefore, what is need is to develop a technology for pressure test to solve the conventional technology problem that it is unable to generate the sufficiently great quantity of data traffic on the network card to perform the pressure test.

### SUMMARY OF THE INVENTION

In order to solve the conventional technology problem that it is unable to generate the sufficiently great quantity of data traffic on the network card to perform the pressure test, the present disclosure is to provide a system using kernel to perform a pressure test on a communication port, and a method thereof.

According to an embodiment, the present disclosure provides a system for using kernel to perform a pressure test on a communication port. The system is applicable to a computer which is installed with at least one processor and at least one network card, and includes an environment adjustment module, a network card service module, a parameter setting module, and a procedure processing module. The environment adjustment module is configured to modify a maximum packet size of a communication port of the at least one network card to be a maximum value. The network card service module is configured to acquire network card information of the at least one network card. The parameter setting module is configured to set a transmission parameter corresponding to the communication port. The procedure processing module is configured to establish at least one test procedure on the at least one processor based on the transmission parameter, to enable the processor to execute the kernel, which is run in the computer, to use a driver of the at least one network card to receive and transmit a test packet according to the transmission parameter, thereby performing the pressure test on the at least one network card.

According to an embodiment, the present disclosure provides a method for using kernel to perform a pressure test on a communication port. The method is applicable to a computer which is installed with at least one processor and at least one network card, and includes following steps: modifying a maximum packet size of a communication port of the at least one network card to be a maximum value; acquiring network card information of the at least one network card; setting a transmission parameter corresponding to the communication port of the at least one network card; and establishing at least one test procedure on the at least one processor according to the transmission parameter, to enable the at least one processor to execute the kernel, which is run in the computer, to use a driver of the at least one network card to receive and transmit a test packet according to the transmission parameter, thereby performing the pressure test on the at least one network card.

According to above content, the difference between the present disclosure and the conventional technology is that the system and the method of the present disclosure may set the transmission parameter corresponding to the communication port, and establish the test procedure on the processor according to the transmission parameter, so that the processor may execute the kernel run in the computer to use the driver of the network card to receive and transmit the test packet through the communication port according to the transmission parameter. As a result, the conventional technology may be solved, and the technical effect of directly performing the pressure test on the different network cards installed in the network device may be achieved.

### BRIEF DESCRIPTION OF THE DRAWINGS

The structure, operating principle and effects of the present disclosure will be described in detail by way of various embodiments which are illustrated in the accompanying drawings.

FIG. 1 is a framework diagram of a system for using kernel to perform a pressure test on a communication port, in accordance with the present disclosure.

FIG. 2 is a flowchart showing the steps in an operation of a method for using kernel to perform a pressure test on a communication port, in accordance with the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

The system and the method of the present disclosure may set the transmission parameters respectively corresponding to one communication port of a network card, and establish a test procedure according to the transmission parameter, so that the processor may perform the test procedure to execute kernel to use a driver of the network card to directly transmit a prebuilt test packet according to the transmission parameter, thereby generating sufficient traffic pressure to test the network card.

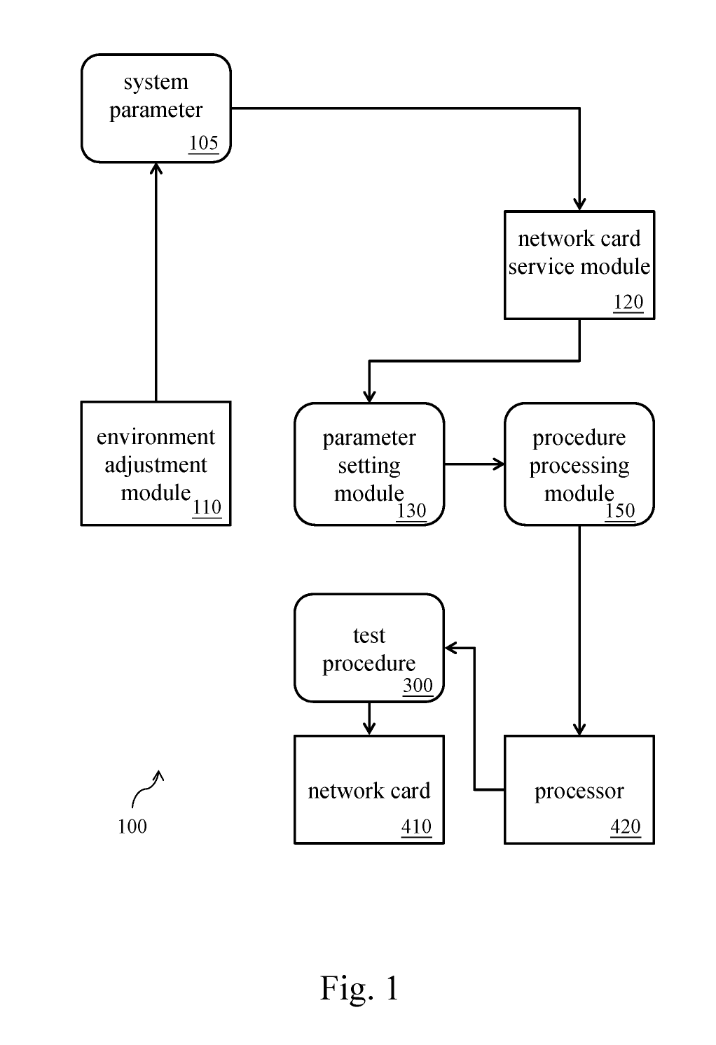

The following refers to FIG. 1, which is a framework diagram of the system for using kernel to perform the pressure test on the communication port, to describe an operation of the system of the present disclosure. As shown in FIG. 1, the system of the present disclosure includes an environment adjustment module 110, a network card service module 120, a parameter setting module 130 and a procedure processing module 150.

The environment adjustment module 110 is configured to modify a maximum packet size of a communication port defined by a computer 100 to a maximum value. The maximum packet size modified by the environment adjustment module 110 is usually a system parameter 105 defined by an operating system which is executed in the computer 100, and the system parameter 105 is used to represent a size of an Ethernet packet transmittable from a communication port of a network card 410 installed in the computer 100. Furthermore, the parameter name indicative of the maximum packet size may be different according to the different operating system executed in the computer 100, for example, the parameter name indicative of the maximum packet size may be “MaxFrameSize”, “JumboMTU”, or “JumboPacket”, but the present disclosure is not limited thereto.

The network card service module 120 is configured to obtain network card information of the network card 410 installed in the computer 100. In general, the network card service module 120 may search the system parameters 105 of the operating system being executed in the computer 100, to find all network cards 410 installed in the computer 100 and obtain the network card information of all network cards 410 installed in the computer 100.

In some embodiments, at least one of the found network card 410 may be locked by the network card service module 120 as an exclusive resource for the system of the present disclosure, and is unable to be used by other procedure other than the test procedure of the present disclosure.

Furthermore, the network card service module 120 may also disable the communication port first and then enable the communication port again, so that the transmission parameter set by the parameter setting module 130 and corresponding to the communication port may work.

The parameter setting module 130 is configured to set the transmission parameter. The transmission parameter set by the parameter setting module 130 may correspond to the communication port of the network card 520 found by the network card service module 120, for example, the transmission parameter may be a corresponding relationship between the communication port and a processor, a connection relationship between the communication ports, an addressing mode, a packet size, or a maximum value of the packet transmitted while the test procedure is performed. In the present disclosure, the maximum value of the packet is also expressed by a maximum amount of packet transmission. In general, the parameter setting module 130 may set the transmission parameter for each communication port through a command interface of an application layer. The transmission parameter set by the parameter setting module 130 may relate to the network card, the processor or a combination thereof, for example, the transmission parameter may be the number of the test procedures executed by the processor for the same network card, but the transmission parameter of the present disclosure is not limited to aforementioned examples.

According to different computers 100 or different test purposes, the connection relationship between the ports set by the parameter setting module 130 may be a single port loopback test or a multiple-port test. In the single port loopback test, the to-be-tested port is connected to a test tool, so that the test packet transmitted from the to-be-tested port may be then transmitted back through the test tool; in other words, in the single port loopback test, the parameter setting module 130 sets the to-be-tested port to connect with itself. In the multiple-port test, different to-be-tested ports may be connected with each other through a network cable, and the parameter setting module 130 may record which communication ports are connected with each other.

The procedure processing module 150 is configured to establish a test procedure 300 in a processor 420 installed in the computer 100, based on the transmission parameters set by the parameter setting module 130, so that the processor 420 may execute kernel of the operating system to use a driver of the network card 410 to receive and transmit the test packets on the communication port of the network card 410 based on the transmission parameter set by the parameter setting module 130, thereby performing a pressure test on the network card 410. For example, the test procedure 300 established by the procedure processing module 150 may be compliant with network driver interface specification (NDIS), the processor 420 may assigned to serve the network card 410 by the kernel, and the processor 420 serving the network card 410 may be assigned by the kernel to execute the test procedure 300. The NDIS is across the transport layer, the network layer, and the data link layer, and defines communication interface specification between network card driver and upper layer protocol (ULP) driver, so that the ULP driver is able to communicate with any type of network card with different hardware architecture.

In some embodiments, the test procedure 300 established by the procedure processing module 150 may be hooked with a packet transmission function of the driver of the network card 410 of installed in the computer 100, to transmit the test packet, which is generated in advance, through the packet transmission function. As a result, the test packet generated by the test procedure 300 in advance may be continuously transmitted by the test procedure 300 directly without being processed by any communication protocol.

In some embodiments, the procedure processing module 150 may delay the establishment of the test procedure 300 on the processor 420 installed in the computer 100, so that the communication port disabled by the network card service module 120 may, after being enabled again, be assigned to be served by the processor 420 executing the test procedure 300.

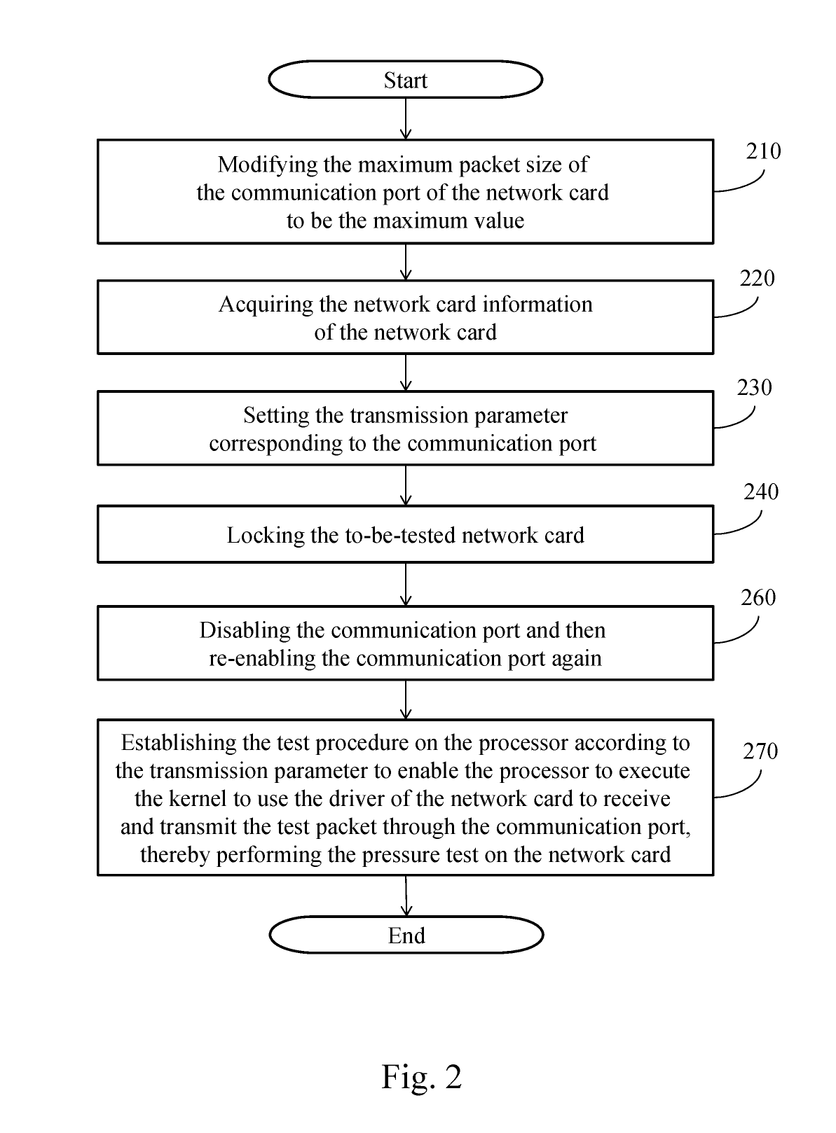

The following refers to an embodiment to illustrate operations of the system and the method of the present disclosure. Please refer to FIG. 2, which is a method for using kernel to perform a pressure test on a communication port, in accordance with the present disclosure.

In a step 210, the maximum packet size of the communication port of the network card 410 is modified to be the maximum value when a user performs the pressure test on the network card 410 installed in the computer 100. In this embodiment, suppose that environment adjustment module 110 may provide the user to find the parameter named as “MaxFrameSize” from a registry (that is, the system parameter 105) of the operating system executed in the computer 100, and provide the user to modify the “MaxFrameSize” parameter to the maximum packet size which is acceptable for the network card 410 installed in the computer 100. For example, the maximum packet size may be 1500.

In a step 220, after the maximum packet size of the communication port of the network card installed in the computer 100 is modified to be the maximum value, the network card service module 120 may acquire the network card information of the network card 410 installed in the computer 100. In this embodiment, suppose that the network card service module 120 may find the network card information of all network cards 410 installed in the computer 100 from a particular part of the registry (the system parameter 105) of the registry of the operating system executing by the computer 100.

In a step 230, after the network card service module 120 acquires the network card information of the network card 410 in the step 220, the parameter setting module 130 may set the transmission parameter corresponding to the communication port of the network card 410 found by the network card service module 120. In this embodiment, the parameter setting module 130 may automatically set the addressing mode, the packet size, the maximum amount of packet transmission while the test procedure is performed, and the number of the test procedures executed by the processor for the network card, and also provide the user to set the corresponding relationship between the communication port and the processor, and the connection relationship between the communication ports.

In a step 240, after the parameter setting module 130 sets the transmission parameters corresponding to the communication port of the network card 410 found by the network card service module 120 (in the step 230), the to-be-tested network card 410 may be locked by the network card service module 120. In this embodiment, suppose that the network card service module 120 is compliant with the NDIS, so that the network card service module 120 may determine which is the to-be-tested network card 410 according to the connection relationship (which is set by the user through the parameter setting module 130) between the communication port and the processor, and/or the connection relationship (which is set by the user through the parameter setting module 130) between the communication ports, that is, the network card, which has the communication port set to correspond to the processor, may be determined as the to-be-tested network card 410, or the network card, which has the communication port set to be in the connection relationship, is determined as the to-be-tested network card 410. Next, the network card service module 120 may use a spin lock function provided by the NDIS to lock the to-be-tested network card 410.

In a step 270, after the parameter setting module 130 sets the transmission parameter corresponding to the communication port of the network card 410 found by the network card service module 120, the procedure processing module 150 may establish the test procedure on the processor 420 according to the transmission parameter, to enable the processor 420 to execute the kernel to use the driver of the network card 410 to receive and transmit the test packet through the communication port of the network card 410, thereby performing the pressure test on the network card 410. In this embodiment, suppose that the computer 100 is installed with three network cards and five processors, one of the three network cards has two communication ports A and B, and each of the other network cards has one communication port, and the communication ports are C and D respectively. When the parameter setting module 130 sets the communication port A and the communication port C to be in connection, the communication port A and the communication port C are connected with each other; in this case, the first processor is assigned to process the data transmitted from the communication port A to the communication port C, and the second processor is assigned to process the data transmitted from the communication port C to the communication port A. The third processor is assigned to process the data transmitted from the communication port B to the communication port D, and the fourth processor is assigned to process the data transmitted from the communication port D to the communication port B.

The procedure processing module 150 may establish, in advance, four test procedures 300 which are compliant with the NDIS, and after each of the test procedures 300 is executed by any one of the four processors 420, the executed test procedure 300 is initialized first, that is, the test procedures 300 may be linked to a specific processor 420 by using a variable “KAFFINITY” and allocate memory that can be used by itself. As a result, through the parameter setting module 130, the user may set the corresponding relationship between the processor 420 and the network card 410, so that the test procedure 300 is able to correspond to the assigned network card 410. For example, after the first test procedure is linked to the first processor, and the second test procedure is linked to the second processor, and the third test procedure is linked to the third processor, and the fourth test procedure is linked to the fourth processor, the first test procedure may correspond to the connection, from the communication port A to the communication port C, served by the first processor, the second test procedure may correspond to the connection, from the communication port C to the communication port A, served by the second processor, the third test procedure may correspond to the connection, from the communication port B to the communication port D, served by the third processor, and the fourth test procedure may correspond to the connection, from the communication port D to the communication port B, served by the fourth processor.

After the test procedure 300 is initialized, the test procedure 300 may sleep until the assigned processor 420 calls. After the pressure test is started, the four test procedures 300 are called and executed by the first to fourth processors respectively. While being executed by the processor 420, the test procedure 300 may generate the test packet first, and then, through the kernel, hook the packet transmission function of the driver of the network card 410 installed in the computer 100, and then continuously transmit the test packet, which is generated in advance, through the hooked packet transmission function, thereby directly generating a significant amount of data traffic on the communication port of the network card to perform the pressure test on the network card until the test time ends. When the test time ends, the execution of the test procedures 300 is stopped and the test procedures 300 enter the sleep states again to wait for next call.

As a result, while the pressure test is performed on the network card according to technology of the present disclosure, the test procedure 300 may use the kernel to directly transmit the test packet on the communication port of the network card, thereby generating a significant amount of data traffic to perform reliable pressure test on the network card.

In aforementioned embodiment, after the parameter setting module 130 sets the transmission parameter corresponding to the communication port of the network card found by the network card service module 120 (in the step 230), the network card service module 120 may disable the communication port and then enable the communication port again in a step 260, so that the transmission parameter set by the parameter setting module 130 may work in the re-enabled communication port. In this embodiment, the network card service module 120 may determine which communication port to be disabled and then re-enabled, according to the corresponding relationship between the communication port and the processor and/or the connection relationship between the communication ports set by the user through the parameter setting module 130; that is, the network card service module 120 may disable the communication port, which is set to correspond to the processor, and then re-enable the communication port, or/and the network card service module 120 may disable the communication ports, which are set to be in connection, and then re-enable the communication ports.

To summarize, the difference between the present disclosure and the conventional technology is that the system and the method of the present disclosure set the transmission parameter corresponding to the port, and establish the test procedure on the processor according to the transmission parameter, so that the processor may execute the kernel run in the computer to use the driver of the network card to receive and transmit the test packet through the communication port according to the transmission parameter. By using above technical means, the conventional technology that a huge amount of data traffic may not be generated on the network card to perform the pressure test on the network card may be solved, and the technical effect of directly performing the pressure test on the different network cards installed in the network device may be achieved.

Furthermore, the system for using the kernel to perform the pressure test on the communication port and a method thereof of the present disclosure may be implemented by hardware, software or a combination thereof, and the implementation of the system and the method may be centralized in a computer system or be distributed in different devices of multiple interconnected computer systems.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A method for using kernel to perform a pressure test on a communication port, applicable to a computer which is installed with at least one processor and at least one network card, and the method comprising:
modifying a maximum packet size of a communication port of the at least one network card to be a maximum value;
acquiring network card information of the at least one network card;
setting a transmission parameter corresponding to the communication port of the at least one network card; and
establishing at least one test procedure on the at least one processor according to the transmission parameter, to enable the at least one processor to execute the kernel, which is run in the computer, to use a driver of the at least one network card to receive and transmit a test packet according to the transmission parameter, thereby performing the pressure test on the at least one network card.

2. The method according to claim 1, wherein the step of setting the transmission parameter corresponding to the communication port further comprises:
defining which processor corresponding to the communication port; and
setting a connection relationship between the communication ports, an addressing mode, a packet size, a maximum amount of packet transmission while the test procedure is being performed, or the number of the test procedure executed by the at least one processor for the at least one network card.

3. The method according to claim 1, wherein the step of enabling the at least one processor to receive and transmit the test packet through the communication port according to the transmission parameter further comprises:
calling the at least one test procedure by the at least one processor.

4. The method according to claim 1, after the step of setting the transmission parameter corresponding to the communication port of the at least one network card, further comprising:
disabling the communication port, and then re-enabling the communication port.

5. The method according to claim 1, wherein the step of enabling the at least one processor to execute the kernel to use the driver of the at least one network card to receive and transmit the test packet according to the transmission parameter further comprises:
executing the at least one test procedure by the at least one processor respectively, and hooking the at least one test procedure with a packet transmission function of the driver of the network card through the kernel, and using the packet transmission function to transmit the test packet which is generated in advance.

6. A system for using kernel to perform a pressure test on a communication port, applicable to a computer which is installed with at least one processor and at least one network card, and the system comprising:
an environment adjustment module configured to modify a maximum packet size of a communication port of the at least one network card to be a maximum value;
a network card service module configured to acquire network card information of the at least one network card;
a parameter setting module configured to set a transmission parameter corresponding to the communication port; and
a procedure processing module configured to establish at least one test procedure on the at least one processor according to the transmission parameter, to enable the at least one processor to execute the kernel, which is run in the computer, to use a driver of the at least one network card to receive and transmit a test packet according to the transmission parameter, thereby performing the pressure test on the at least one network card.

7. The system according to claim 6, wherein the transmission parameter corresponding to the communication port comprises a corresponding relationship between the communication port and the at least one processor, a connection relationship between the communication ports, an addressing mode, a packet size, a maximum amount of packet transmission while the test procedure is being executed, or the number of the test procedure executed by the at least one processor for the at least one network card.

8. The system according to claim 6, wherein the network card service module is configured to lock the at least one network card.

9. The system according to claim 6, wherein the network card service module further disables the communication port, and then re-enables the communication port.

10. The system according to claim 6, wherein the test procedure hooks a packet transmission function of the driver of the at least one network card through the kernel, and uses the packet transmission function to transmit the test packet which is generated in advance.
